(19) United States
(12) Patent Application Publication
(10) Pub. No.: US 2007/0073608 A1
(43) Pub. Date: Mar. 29, 2007

(54) Cash only marketplace system for trading securities

(76) Inventor: Crisostomo B. Garcia, Rancho Santa Fe, CA (US)

Correspondence Address: NATH & ASSOCIATES, 112 South West Street, Alexandria, VA, 22314, US

(21) Appl. No.: 11/347,322

(22) Filed: Feb. 6, 2006

Related U.S. Application Data
(60) Provisional application No. 60/719,563, filed on Sep. 23, 2005.

(51) Int. Cl. G06Q 40/00

(52) U.S. Cl. 705/37

(57) ABSTRACT

A method, system and programmed medium for use by buyers and sellers in the trading of a security. All transactions will involve only cash. The system provides an electronic marketplace in which only customers are involved in any trade. Brokers, specialists, market makers, and stock transfer agents are not required. In this electronic marketplace system, customers have a direct connection to the securities market. Shares representative of underlying securities are traded, and ownership of the underlying security is not taken. In each transaction, a transaction number is generated to code price, volume, date, owner and other information, and a processor uses the transaction record to reconcile accounts in an accounts database. Due to efficiency of the system, transaction costs in this system may be set near or at zero, depending on the commission fee set by the system. If desired, the spread between bid and asked prices may be eliminated.

### CROSS REFERENCE TO RELATED APPLICATIONS

The present application claims priority of U.S. Provisional Patent Application Ser. No. 60/719,563, filed Sep. 23, 2005, which is incorporated by reference herein in its entirety.

### FIELD OF THE INVENTION

The present subject matter relates generally to a cash-based, intermediary-free automatic securities trading system for trading securities having cash values based on underlying securities and in which a current actual market price may be provided in addition to current “bid” and “asked” quotes.

### BACKGROUND OF THE INVENTION

In the present context, the term security relates to obligations representative of value, whether intrinsic or extrinsic. The security need not necessarily meet the definition of security under Section 2 of the Securities Act of 1933, 15 U.S.C. §77b, or any state statute.

Traders buy and sell securities, often in the hopes of short-term profit. An example of a frequently traded security is common stock. Traders may also utilize options to sell or buy, known as puts and calls respectively, or derivative instruments to trade based on stock prices. Commonly, in trading stocks, a first change in ownership must take place. A security must be bought or it must be borrowed and sold short. In order to make a profit, the trader must sell purchased shares or buy shares to cover shares sold short. Again, a change in ownership must take place. Each change in ownership requires a settlement and data entry to reflect the change in ownership. Change in ownership incurs stock transfer costs, and may be reflected by issuance of a new stock certificate. Alternatively, a broker holding stock on behalf of an investor may adjust its ownership records accordingly. In order to make a profit on the trades, the investor must make a gain in excess of the costs inherent in trading. Costs include brokers' commissions and the spread between bid and asked prices, discussed further below.

These costs are inherent in conventional forms of trading. Customers who trade through online brokerage accounts do not have a direct connection to the securities markets. Rather, orders are sent over the Internet to brokers, who in turn decide which markets to send them to for execution. Orders may be sent to a national exchange such as the New York Stock Exchange (NYSE) or the Chicago Board Options Exchange (CBOE), to a NASDAQ market maker, to an electronic communications network (ECN), to a regional exchange, to a firm called a “third market maker,” or to another division of the broker's company where the order is filled from the company's inventory. When a transaction occurs, a customer incurs two transaction costs: a commission fee that the broker receives for the execution of the trade, and the spread (the difference between the bid and the ask) that the specialist or market maker receives on execution of the trade. In a minority of transactions, such as when the buyer and seller are both customers of a broker filling the order from inventory, then the spread may be zero. Securities regulations permit brokerage houses to make their own markets in “over the counter” traded stocks, for example. Generally, as is the case with stocks listed on a major exchange or not handled through inventory, a transaction will require the participation of a specialist or market maker to match bids for stocks to purchase to “asks,” i.e. offers to sell at a price. The specialist or market maker is compensated by maintaining a spread between purchase and sale price in the same transaction. In as much as the volume of trades in the course of a day is considerable, and even though the spreads are minimum fractional increments, the spread can yield lucrative profits to specialists and market makers. In large measure, this cost is just compensation for the liquidity that specialists and market makers provide.

While the cost of the spread may be justified, the necessity of dealing with a spread significantly reduces the ability of an investor to profit or recoup an investment when there is minimal price movement of a stock. Even more significant is the effect of the spread on return on investment with respect to options. In the options market, the spread can be higher than ten percent of the bid or ask in the most active options. Option prices are generated according to different option pricing models. The Black/Scholes and Cox/Rubinstein pricing models are examples of well-known pricing models. Pricing models normally provide for an option price such that the exercise price plus the option price will end up within or near the spread. The option pricing models are effectively unusable in the absence of significant price movement. The investor must also benefit from price movement sufficient to exceed the broker's commissions paid on buying and selling the stock.

Since the advent of the digital age, a number of automated electronic transaction systems have been provided. The automated trading systems share the above-described characteristics of requiring two changes in ownership to enter and exit a trade in a stock (“trade” here also referring to use of options or derivatives), of the brokers' commissions and of use of the spread. Automation in the securities field has led to decreases in brokers' commissions as a percentage of the purchase or sale price of stock. U.S. Pat. No. 4,674,044 discloses an automated securities trading system which processes buy and sell orders for securities. The system retrieves and stores the best current bid and asked prices; qualifies customer buy/sell orders for execution; executes the orders; and reports the trade particulars to customers and to national stock price reporting systems. The system apparatus also determines and monitors stock inventory and profit for the market maker. The spread is an essential part of the system.

A more recent system is disclosed in U.S. Pat. No. 6,505,174. A server computer receives buy and sell orders for derivative financial instruments from a plurality of client computers. The server computer matches the buy orders to the sell orders and then generates a market price through the use of a virtual specialist program executed by the server computer. The virtual specialist program responds to an imbalance in the matching of the buy and sell orders. The spread is created by the virtual specialist. U.S. Pat. No. 6,016,483 discloses a computer-based system for determining a set of opening prices for a number of series of options traded on an options exchange and for allocating public order imbalances at the opening of trading. Again, the market maker differential is applied. U.S. Pat. No. 6,014,643 discloses a trading system in which a plurality of data processing systems are connected by a communications network and are used by a buyer for obtaining title to a security. U.S. Pat. No. 5,995,947 discloses a system in which obligations other than stocks are traded. Interactive mortgage and loan information is provided, and loans are traded in real-time. U.S. Pat. No. 5,873,071 illustrates a computer method and system for an intermediated exchange used for commodities. U.S. Pat. No. 4,903,201 discloses an automated futures trading exchange. Each of these systems requires the participation of brokers and market makers in trades.

U.S. Pat. No. 6,513,020 discloses a system for trading Proxy Assets. The Proxy Assets are claims on the pooled funds in a bank. Their value varies with selected indexes. Proxy Assets must be issued in complete sets. A complete set consists of an Up Proxy Asset and a Down Proxy Asset, whose value increases or decreases with respect to an index. The trading system executes orders by trading existing Proxy Asset shares or issuing or redeeming Proxy Asset shares in complete sets. Proxy assets do not require ownership of an underlying property, e.g., real estate; the trading system cannot simply list a proxy asset. However, they do not serve as a substitute for trading stock. Maintaining liquidity is made more complex by the need to trade complete sets.

Another aspect of prior art trades is that an individual entering an order to buy or sell “at market,” i.e. the price at the time the exchange receives and matches the order to available shares, does not find out the execution price on a “market” until after the transaction has been completed. Currently available information includes bid price and asked price. A current market price reflects a trade that has already been executed. Price generation is performed after an order is entered. U.S. Pat. No. 6,505,174 discloses a computer-implemented securities trading system with a virtual specialist function. The patent discusses the computer-implemented system as well as prior manual forms of trading. In both forms, buy and sell orders are matched and a trade price is reached after the orders are entered. The computer-implemented system matches the buy orders to the sell orders and then generates a market price through the use of a virtual specialist program. A formula is used to set a projected price movement. However, actual price prior to entry of a market order is still not known.

### SUMMARY OF THE INVENTION

It is desired to provide a fully automated system in which only customers are involved in any trade. In the present embodiments, customers have a direct connection to an electronic marketplace system functioning as a securities market. Orders to buy at a particular price will be referred to as “bids,” and orders to sell at a particular price will be referred to as “asks.” Transaction costs in terms of brokerage and specialist fees may be near or at zero. If transaction costs are zero, then customers can buy and sell at will without incurring losses simply by virtue of having engaged in transactions. The present embodiments do not need to replace current trading systems, but may expand the alternatives for trading. Costless hedging by option traders is one use of the present system.

In a preferred form, the present trading system requires the existence of the existing external stock exchanges to provide price data in order for the system to be functional. Posted prices comprise an open book for bidders and offerors which is available widely over the Internet to subscribers by services that provide substantially real time price data. Openness of the system encourages use and liquidity without a market maker. In the preferred embodiment, liquidity is expected to be facilitated because all trades are filled inside the spread, fractional portions of orders are filled, and odd lots as small as a dollar or an order for a fractional unit of a security are filled without significant transaction costs or loss of position in the trading queue for a customer. Because a “round-trip trade,” i.e., purchase and sale, of a security in the system is made without need for physical ownership of the underlying security, trades in the system may be completely in cash.

Briefly stated, in accordance with embodiments of the present invention a method, system and programmed medium are provided for use by buyers and sellers in the trading of an obligation, e.g., a security, without need for physical ownership of the security. The obligation is a derivative obligation having a price based on the price of an underlying security, such as a security traded on an external exchange. The price of the obligation may be the same as the price of the underlying security. The obligations may be, but need not necessarily be, securities within the meaning of the definition of security under Section 2 of the Securities Act of 1933, 15 U.S.C. §77b, or any statute other than a United States federal statute. Price data is imported to the trading system from the outside exchange. The price data preferably includes current bid and asked data on the external exchange. A price data generator in the trading system generates current price data for at least the obligation and a price data register to provide system users with access to the price data of an obligation. In response to a matching of bid orders and ask offers, a trade is executed. As a part of the trade, a transaction record is created. The transaction record includes a transaction number, or other intelligence, being coded to be indicative of price information, a bidder's identification and an offeror's identification. A database stores transaction numbers. The bids and asks on the security may be posted to be accessible through a wide area network. When a bid and an ask are matched, a transaction number from a previous transaction is accessed, and utilized to reconcile accounts. The system credits the offeror's account and debits the matched bidder's account. A new transaction number is created. In one form, if a seller is selling short, a unique, time-based transaction number is generated indicating the seller's name. When a buyer is covering for a security that was sold short earlier, the earlier transaction record is accessed and utilized for computation of a resulting balance in the buyer's account. Put and call options are also accommodated.

In a further form, the price data may also be utilized to generate a current actual market price. The trading system registers a total volume of current bid orders and a total volume of ask offers for each price at which there is a bid or ask. Market price is determined by determining aggregate number of bid orders at the price on the abscissa or at a higher price and the aggregate number of units listed at the price on the abscissa or at a lower price. A current actual market price is generated to inform users of the trading system of a price at which “market” orders will be executed.

### BRIEF DESCRIPTION OF THE DRAWINGS

FIG. 1 is a block diagram of an embodiment of the present invention interacting in an operational environment;

FIG. 2 is a block diagram illustrating the system of FIG. 1;

FIG. 3 is a flow chart illustrative of a trade process;

FIG. 4 is a chart showing bids and offers, and the corresponding volumes for an index;

FIG. 5, consisting of FIGS. 5a and 5b, is a chart showing the demand and supply curves, and the market price for the bids and offers illustrated in FIG. 4;

FIG. 6 is a chart showing a list of bids and offers, and corresponding volumes after crossing the affected bids and offers of FIG. 4;

FIG. 7 is a chart showing bids and offers, and the corresponding volumes for an index in a preferred form;

FIG. 8 is a chart showing a list of bids and offers, and corresponding volumes after crossing the affected bids and offers of FIG. 7;

FIG. 9 is a chart showing a transaction recorded by the system for a particular trade;

FIG. 10 is a chart showing a transaction recorded by the system for a particular trade if there is a commission fee of ten cents per round-trip trade;

FIG. 11 is a chart showing the transaction in the exercise of the security of FIG. 9 where the owner shows a profit from the trade;

FIG. 12 is a chart showing the transaction in the exercise of the security of FIG. 9 where the owner shows a loss from the trade;

FIG. 13 is a chart showing all the existing options for an index at a given expiration date;

FIG. 14 is a chart showing a list of bids and offers, and the corresponding volumes for an option at a given strike price and expiration date;

FIG. 15, consisting of FIGS. 15a and 15b, is a chart showing the demand and supply curves, and the market price for the bids and offers illustrated in FIG. 14;

FIG. 16 is a chart showing bids and offers, and the corresponding volumes for an index in a preferred form;

FIG. 17 is a chart showing a transaction recorded by the system for a particular trade of a call option;

FIG. 18 is a chart showing the transaction in the exercise of the option of FIG. 17;

FIG. 19 is a chart showing a transaction recorded by the system for a particular trade of a put option; and

FIG. 20 is a chart showing the transaction in the exercise of the option of FIG. 19.

### DETAILED DESCRIPTION

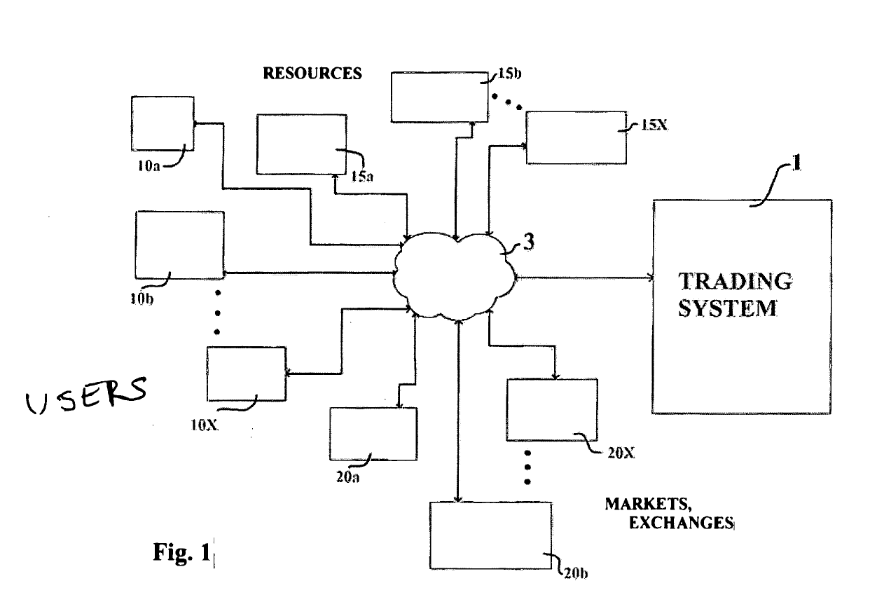

In accordance with embodiments of the present invention a method, system and programmed medium are provided for use by buyers and sellers in the trading of an obligation such as a security (e.g., a stock, an index, or an option on a stock or index) without need for physical ownership of the security. A detailed description of transactions begins with the discussion of FIG. 3, below. A trading system 1 for buying and selling obligations is illustrated in block diagrammatic form in FIG. 1. The obligations may take many forms. In one general form, the obligations comprise a contract to buy and sell obligations at a price set in accordance with a current price corresponding to market bid and ask prices of an underlying obligation. The underlying obligation is neither purchased nor sold. The underlying obligation may comprise common stock, whether listed or over the counter, bonds, put or call options, mortgages, treasury bills, futures, indexes or index funds, derivative securities, bonds or other marketed items.

The trading system 1 is preferably coupled to a network 3, which is preferably a wide area network (WAN), e.g. the Internet or a network coupled to the Internet, although the trading system 1 could be coupled to a local area network (LAN) if desired. The trading system 1 may interact with any number of users 10. The users 10 may engage in trades, examine their accounts or perform other functions. In FIG. 1, users 10a and 10b through 10X are illustrated to represent the users 10, where X is an alpha combination corresponding to the number of users interacting with the trading system 1. The trading system 1 may also interact with any number of markets 15a and 15b through 15X which trade underlying obligations. In many instances, the market 15 will be an exchange, although there are many other markets that can establish a current price for an obligation. The trading system 1 may interact with any number of additional resources 20a and 20b through 20X. The additional resources could, for example comprise other sources of prices for traded obligations than exchanges such as news services, banks or governments. The additional resources 20 could also comprise information sources or accounting services for the users 10 or the trading system 1.

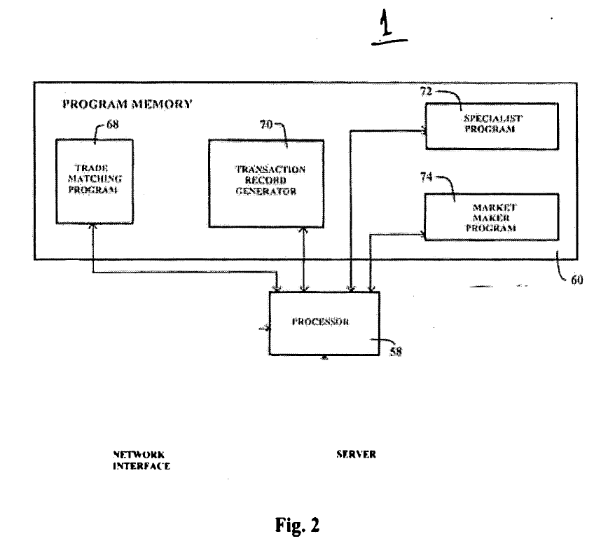

FIG. 2 is a block diagram illustrating the trading system 1. The trading system 1 and apparatus interacting therewith can respond to commands of a machine-readable medium. A machine-readable medium includes any mechanism that provides (i.e., stores and/or transmits) information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.) etc. The particular architecture illustrated of the trading system 1 is illustrative of the functions performed, and many alternatives may be provided. The discrete functional units of the trading system 1 may be embodied in a number of ways well known in the art to provide a described operation. For example, discrete databases are illustrated. However the various databases could comprise locations within a single memory unit.

The trading system 1 communicates with outside networks and system modules via a communications bus 50. A network interface 54 couples the trading system 1 to the network 3 via the communications bus 50. Also connected to the communications bus 50 are a local server 56, a processor 58, a program memory 60, a data memory 62 and a plurality of databases, including, without limitation, an accounts database 64, a price database 66. The price database 66 may further comprise separate databases for different types of securities. Included in the program memory 60 are a trade matching program 68 and a transaction record generator 70. In one embodiment, the program memory 60 may further include a specialist program 72 and a market maker program 74. The specialist program 72 and the market maker program 74 may comprise prior art programs. A settlement generator 76 matches bid and ask orders to execute trades based on one of a selected number of criteria as further described below. A price data register 78 provides system users with access to a current market price. A price generator 80 provides the current market price, preferably stored by the price data register 78. A current market price is generated as further described below after the description of FIG. 3. The settlement generator 76, price data register 78 and price generator 80 are illustrated as discrete components for purposes of description. While they may be embodied as separate components, in most preferred forms, the functions of these components may be distributed through the processor 58, the data memory 62, the communications bus 50 and other components. The processor 58 may also comprise programs for handling stock splits, cash and stock dividends, and other special situations.

The server 56 communicates with users 10 (FIG. 1) and other sources of information described with respect to FIG. 1. Limited access may be provided to the server 56 such as by requiring users to use passwords. The server 56 serves as a receiver configured to receive bid and ask information from users 10 comprising prospective buyers and sellers respectively. The server also queries information sources to obtain current price information, and may also obtain other price information. External price data as well as inputs from the users 10 may be provided to the price database 66 and the price generator 80. The price database 66 may maintain historical price data as well as acting as a price data register to provide system users 10 with access to the price data associated with an obligation. Generally, the price data provided to users 10 will be a current price, bid and ask within a preselected number of minutes after the price data appears on an exchange.

For setting a price in accordance with a price received from an external exchange, the server 56 obtains price data from external information sources, e.g., a stock exchange. The server price has been determined by whatever method is used by that exchange. For example, the NYSE generally sets prices by auction. The NASDAQ generally sets prices by negotiation. In selected situations, a price on either of these exchanges could be set by a specialist. If an underlying security is a stock or an option on the stock, the system's posted price of the security may be based on the latest logged trade for the stock on an existing exchange external to the trading system 1. Otherwise, if the underlying security is an index or an option on the index, the system's posted price of the security may be calculated based on the latest logged trades of the stocks composing the index. Price data such as the bids, asks and the “inside quote” are provided to the price database 66. Asks may be referred to as offers since an ask is an offer to sell at a particular price. The inside quote is the highest or best bid, and the lowest or best ask. If the underlying security is not traded, such as in an index, the inside quote is the posted price for the underlying security, or the average of the posted prices for the securities comprising the underlying security, on its respective exchange. The trading system 1 will normally provide access to the price data to users 10.

The processor 58 utilizes the trade-matching program 68 to match selected bids and asks in accordance with a rule. Current bids and asks may be registered in the data memory 62. The bids and asks are ranked, with the best bids and asks, or offers, displayed first. “Best” is highest in the case of a bid and lowest in the case of an ask. The rule requires use of a method to match bids to asks in accordance with the system's posted inside quote and/or the relative price. If the best bid is greater than or equal to the best ask, a trade is executed by the processor 58. In the preferred form, the “current actual market price” must also be in between the best bid and the best ask before the processor 58 executes a trade. The “current actual market price” is a price in the system's posted inside quote. In one preferred form, the current actual market price is chosen to be the average of the system's posted best bid and the system's posted best ask. The number of shares traded, which may be fractional, equals the smaller of the number of shares sought by the best bidders and the number of shares asked by the best offerors. In the preferred form, the number of shares traded equals the smaller of the number of shares sought by the bidders above or at the current actual market price and the number of shares asked by the offerors below or at the current actual market price.

The rule also requires a method to break ties when there is an imbalance of bids and asks eligible for matching. The tiebreaker could comprise the time the customer entered the order, a customer's trading volume as stored in the accounts database 64, and size of a current order or other parameter. The processor 58 computes financial information associated with the trade, and provides information to the accounts database 64. The trading system 1 credits the affected offerors' accounts, and debits the affected bidders'accounts, with the “trade value”, the current actual market price multiplied by the number of shares traded.

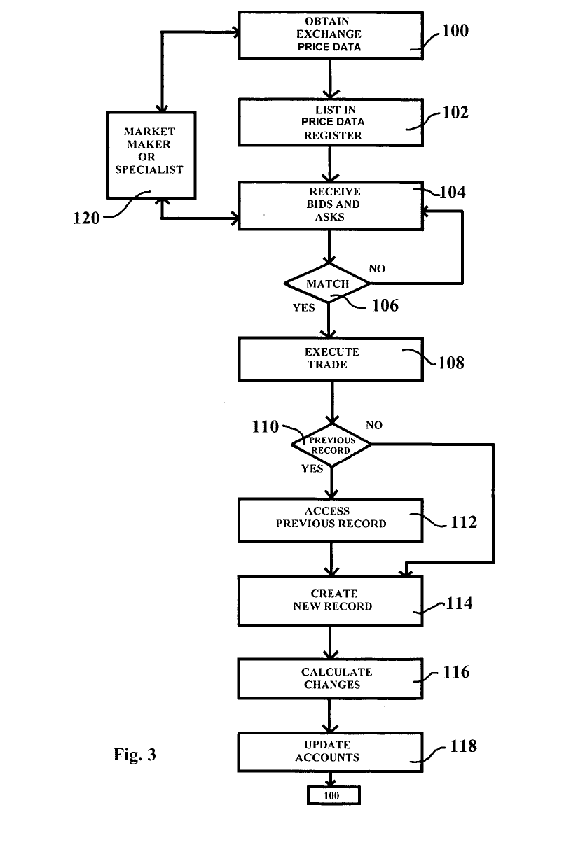

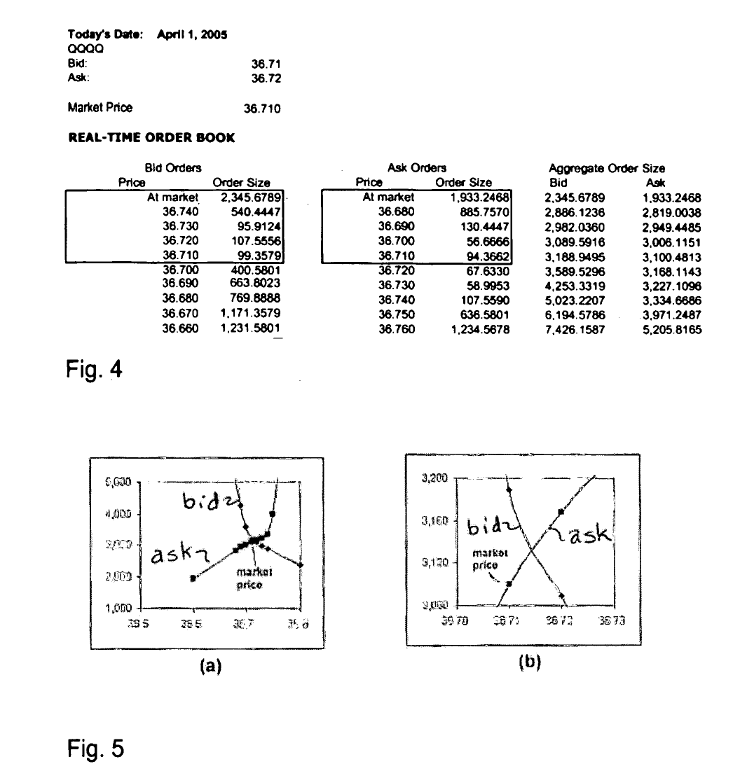

Also, when a trade is executed, the processor 58 utilizes the transaction record generator 70 to generate a transaction record. The transaction record will preferably be a transaction number, but other forms of intelligence may be utilized. The transaction number is coded to be indicative of significant information further described with respect to FIG. 4. Significant information customarily includes price, volume, a bidder's identification, an offeror's identification and a date. Transaction numbers may be stored in the accounts database 64. The transaction number may also be referred to as a serial number.

In a given transaction, the affected users 10, i.e., the affected bidder and the affected offeror, volume, the price, and the exercise price if an option are all coded into a transaction number. If the seller is closing an open trade, i.e., if the seller is selling a security bought earlier within the trading system 1, the owned security's transaction number and seller on record are also coded in the transaction number. Otherwise, if the seller is selling short, a unique, time-based transaction number generated by the system, and the seller's name are coded in the transaction number. If the buyer is closing an open trade, i.e., if the buyer is covering for a security that was sold short earlier, the owner's name on record for the security sold short is recorded as the owner of this security. Otherwise, the buyer's name is recorded as the owner of this security.

An open trade may be exercised at any time prior to expiration. If the open trade is a stock or index, the owner's account is credited, and the seller's account is debited with the trade value based on the system's posted price of the stock or index (at the time of exercise). If the open trade is an in-the-money call, i.e., an option to buy at less than the current market price, the owner's account is credited, and the seller's security is debited with the trade value based on the difference between the system's posted price of the security and the strike price on record. In the preferred form, the call option is cancelled, and a stock trade is executed in which the owner's account is debited, and the seller's account is credited with the trade value equal to the strike price on record. Finally, if the open trade is an in-the-money put, i.e., an option to sell at more than the current market price, the owner's account is credited, and the seller's account is debited with the trade value based on the difference between the strike price on record and the trading system 1's posted price of the security. In the preferred form, the put option is cancelled, and a stock trade is executed in which the owner's account is credited, and the seller's account is debited with the trade value equal to the strike price on record. The trading system 1 can accommodate exercise of an open trade on all or part of the total number of units or shares subject to the open trade. Open trades normally have expiration dates after which they may not be exercised. At expiration of the open trade, the open trade may be automatically exercised by the trading system 1.

FIG. 3 is a flow chart illustrative of a trade process. The order of steps in FIG. 3 may be altered unless a logical contradiction could result. For example, a current price for a security could not be posted before a corresponding price of an underlying security is obtained from an exchange. At block 100, the server 56 obtains the price data for a selected underlying security. The price data is periodically updated. The price data is made available for access by users 10 at block 102. Bids and asks are received from the users 10 at block 104, and compared by the processor 58 in accordance with the trade matching program 68, block 106. If no matches are made, no trade is executed, and the trading system 1 returns to block 104 to collect bids and asks for comparison. If matches are made, trades are executed at block 108. The system queries the accounts database 64 to access relevant transaction records. A transaction record will include a prior purchase price as well as strike price if the obligation is an option. If a transaction involves an open trade, a prior transaction record is accessed at block 112. If there is no prior transaction record, operation proceeds to block 114 where a new transaction record is created. The consequences of the transaction are calculated, e.g., debit to a buyer and credit to a seller, and at block 118, the account records of the parties to a transaction are updated. Optionally, at block 120, a market maker or specialist program may be utilized, for example between blocks 102 and 104, to create a market in response to which bids or asks are received. At the end of the trade process, the server 56 returns to block 100.

FIG. 4 is a chart illustrating a typical book of bids and offers in the trading system 1 where the underlying security is the QQQQ Index, also referred to as the NASDAQ 100 Index. This index is an index maintained by the National Association of Securities Dealers (NASDAQ), New York, N.Y. based on the prices of NASDAQ selected stocks. The QQQQ Index is produced by the NASDAQ Automated Quotation System). The particular index illustrated expires on the third Friday in July of 2005. Other expiration dates (including an index with an indefinite, i.e., no, expiration date) for the index are also available for trading. The present illustration occurred before the expiration date. In the preferred embodiment, on the expiration date, all trades that are open will automatically be exercised by the system. The bids and offers received from users 10 are posted, with best bids and offers to sell, or asks, ranked first. Best bids are the highest, and best asks are the lowest.

The server 56 receives real-time data indicative of external exchange prices from data providers. The received data is stored in the price database 66 and becomes trading system 1 price data. The trading system 1 can process an order or offer for fractional units without significant costs or loss of position in the trading queue for the customer. In one embodiment, bids and asks are compared to the external price data. Current external price data comprises current actual market data. The settlement generator 76 (FIG. 2) executes trades when a bid or ask matches the external price.

In another embodiment, the settlement generator 76 utilizes a current market price generated by the trading system 1. This embodiment is described with respect to FIGS. 5-8. FIG. 5 consists of FIGS. 5a and 5b, which are graphs illustrating aggregate supply and demand curves incorporating the data of FIG. 4. In each graph, the abscissa is price and the ordinate is volume. FIGS. 4 and 5 are used to describe the structure and operation of embodiments in which the trading system 1 provides a current actual market price. The aggregate supply and demand curves may be used to determine the “market” or “equilibrium” price, the price at which the market clears. FIG. 5b is a partial, detailed view of FIG. 5a. In each curve marked bid, the volume is the aggregate number of bid orders at the price on the abscissa or at a higher price. In each curve label ask, the volume is the aggregate number of units listed at the price on the abscissa or at a lower price. In this description the number of orders is the number of units for which there is an order. The trading system 1 comprises processor 56 and associated memories comprise an order register to register a total volume of current bid orders and of ask offers at each price for which there are bids and asks or at each price within a preselected range. Market price is determined by determining aggregate number of bid orders at the price on the abscissa or at a higher price and the aggregate number of units listed at the price on the abscissa or at a lower price. A current actual market price is generated to inform users of the trading system of a price at which “market” orders will be executed.

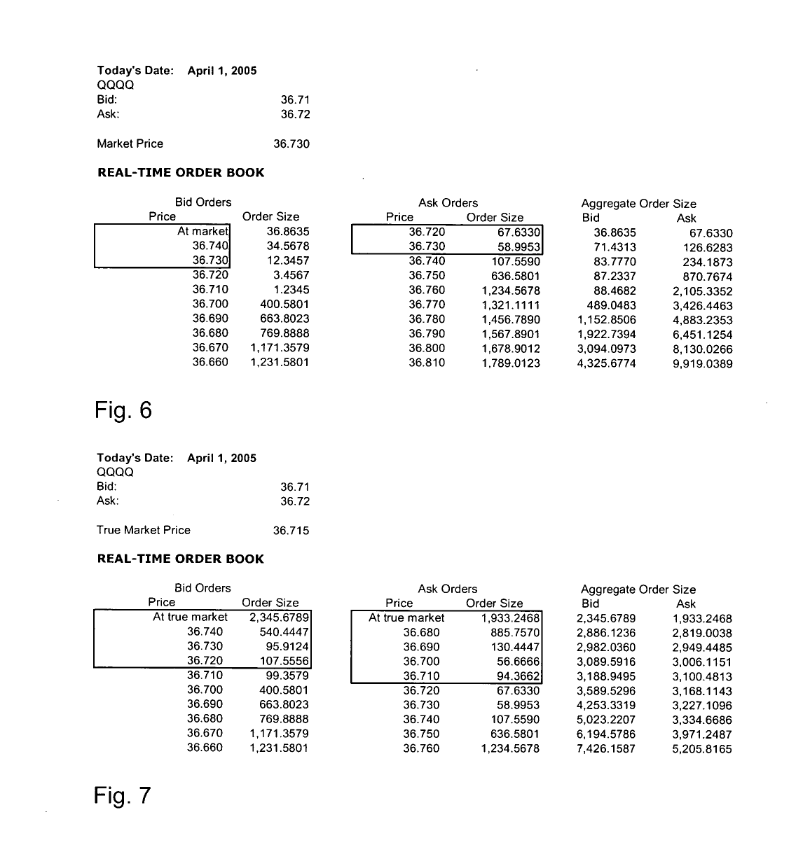

In the FIG. 4, there are 2,345.6789 buy orders of various sizes from various customers at market price, and 1,933.2468 sell orders from various customers at market price. There are 540.4447 bid orders from various customers at 36.74 or better, and 885.757 ask orders from various customers at 36.68 or better. The system may have collected these orders by processing orders only at every fixed time interval, say at every 10 minutes. The advantage of waiting is that more orders will likely be accumulated in a selected time span than will be accumulated at a particular instant. Increased numbers of bid and ask offers increase liquidity and price discovery. In the present illustration, the market price is 36.710. The bids at 36.710 or higher are enclosed in a box in FIG. 4. The total of the bid orders is 3188.9495 units. The ask offers at 36.710 or below are enclosed in a box FIG. 4. The sum of these offers is 3,100.4813 units. The amount of bid orders in excess of ask offers is 88.4682 units. Therefore, orders for 88.4682 units remain unfilled at 36.710. The filled bid orders are chosen according to the “First In, First Out” rule, as illustrated in the FIG. 6, which is a chart showing a list of bids and offers, and corresponding volumes after crossing the affected bids and offers of FIG. 4. The new market price is now 36.73. Fractional portions of bids and offers are crossed in the proposed system.

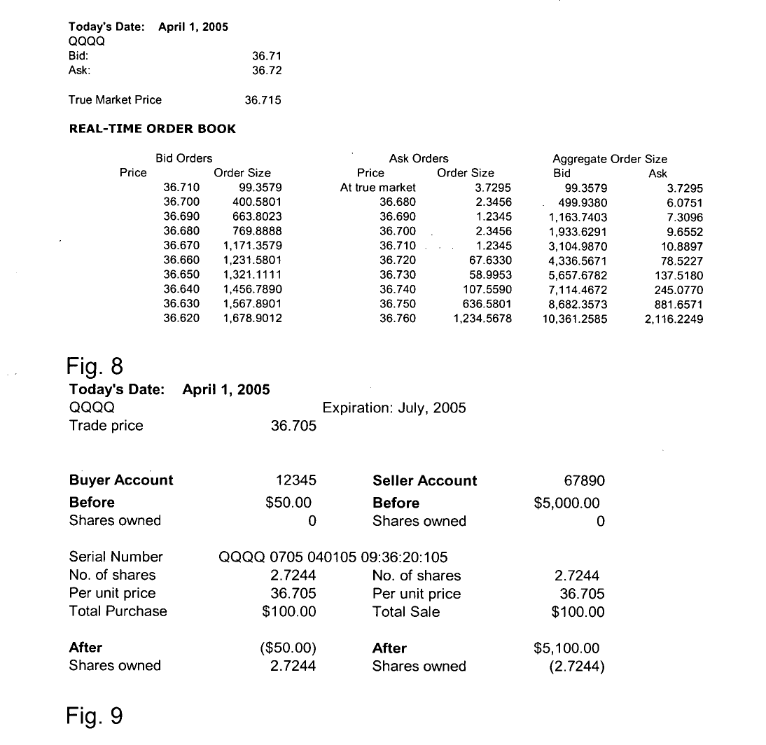

In the preferred form, FIG. 7, the current actual market price is 36.715, the average of the system's bid and ask. There are 2,345.6789 buy orders of various sizes from various customers at current actual market price or better, and 1,933.2468 sell orders from various customers at current actual market price or better. There are 540.4447 bid orders from various customers at current actual market price or better, but no worse than 36.74, and 885.757 ask orders from various customers at current actual market price or better, but no worse than 36.68. An advantage of this preferred form is that customers always do better than or the same as when trading in the traditional marketplace. FIG. 8 shows the typical book of bids and offers after crossing, i.e., matching of orders through use of the trade-matching program 68, of the bids and offers displayed in FIG. 7. In this illustration, 3,089.5916 units are traded at 36.715. Since there were 3,100.4813 asks, or ask offers, 10.8897 ask orders remain unfilled at 36.715. The filled ask orders are chosen according to the “First In, First Out” rule. Fractional portions of bids and offers are crossed in the proposed system. Observe that the ask of 36.68 is not filled even though it is showing below the bid of 36.70. For the ask order to get filled, it must change from “sell at current actual market price or better, but no worse than 36.68” to, e.g., “sell at 36.70 or better”.

In another embodiment, actual market price may be determined by a different method at different times. For example, the processor 58 and price generator 80 (FIG. 2) could be programmed such that at opening, the external price is the actual market price. The processor 58 and price generator 80 can then use the aggregate totals as described with respect to FIGS. 4-8 to generate an actual market price in response to bids and asks entered by the users 10.

FIG. 9 shows an example of generation of a transaction record for a particular trade. The transaction record generated in the present illustration is a transaction serial number. The serial number generated for the illustrated trade is QQQQ 0705 040105 09:36:20:105. A number of selected parameters are coded into the transaction record. The serial number indicates that the underlying security is the QQQQ Index. The field 0705 indicates that the index units expire in July 2005. The field 040105 09:36:20:105 indicates the trade date of Apr. 1, 2005 at 9:36:20:105 ET. Eastern Time is used in this illustration because the relevant exchange is in New York, but any time zone could be selected. The field 105 indicates that the subject transaction was made on the 105^{th} millisecond at that time. The transaction record provides a unique identifier for the transaction. Account Nos. 12345 and 67890 each represent one of the users 10, who are first time traders of the QQQQ that expires on July 2005. Account No. 12345 is debited $100, and account No. 67890 is credited the same amount for the trade of 2.7244 shares of the security. The system records Account No. 12345 as the owner of 2.7244 shares of the security and account No. 67890 as the seller of the security. A transaction number is generated, but a prior transaction number is not accessed.

The sale and the purchase are referred to as opposite sides of the transaction. The sale transaction record and the purchase transaction record may also be referred to as opposite sides of the transaction. In one preferred form, the processor 58 (FIG. 2) is configured to allow the system 1 to provide an interface to permit a user to sell or buy obligations previously bought or sold respectively. For purposes of the present description, this is referred to as selling or buying to the other side of the transaction. A rule is provided, preferably in the processor 58, so that the purchase or sale to the other side of the transaction is made at, i.e., in accordance with, a specified pricing formula. This process is illustrated in FIG. 3 in that at block 104, the access is made to the other side of the transaction. At block 106, transaction numbers are matched rather than prices. At block 108, the trade is executed in accordance with the rule.

If account no. 67890 is selling an owned security that was previously purchased on the trading system 1, then the trading system 1 retrieves the transaction record for previous purchase. In the present illustration, the serial number for this transaction is QQQQ 0705 032205 13:02:06:526. The serial number indicates that the security was purchased on Mar. 22, 2005 at 13:02:06:526 ET. If account no. 87654 was the first seller on record of the security, trading system 1 includes the aforementioned serial number to this transaction, and records account no. 87654 as the seller of this security and it is noted that this account is selling short. Account no. 12345 is the owner on record of the security.

If account no. 12345 is covering a security sold short, then the trading system 1 retrieves the transaction on record for the security sold short. If the serial number for this transaction is QQQQ 0705 021405 10:14:59:001, the serial number indicates that the security was sold short on Feb. 14, 2005 at 10:14:59:001 ET. If Account no. 12345 sold the security to account no. 98765 the trading system 1 includes the aforementioned serial number to this transaction in the accounts database 64, and records account nos. 98765 and 67890 as the owner of this security and the seller respectively.

If account no. 67890 is selling an owned security, and account no. 12345 is covering a security sold short, then the trading system 1 retrieves the transactions on record for the owned security and for the security sold short. Suppose the serial number for these transactions are QQQQ 0705 032205 13:02:06:526 and QQQQ 0705 021405 10:14:59:001 respectively. Suppose account no. 87654 is the seller on record of the former security and account no. 98765 is the owner of record of the latter security. The current transaction numbers are recorded in the two affected accounts. The trading system 1 records account no. 98765 as the owner and account no. 87654 as the seller of this security respectively. Also, the account numbers 12345 and 67890 are respectively debited and credited.

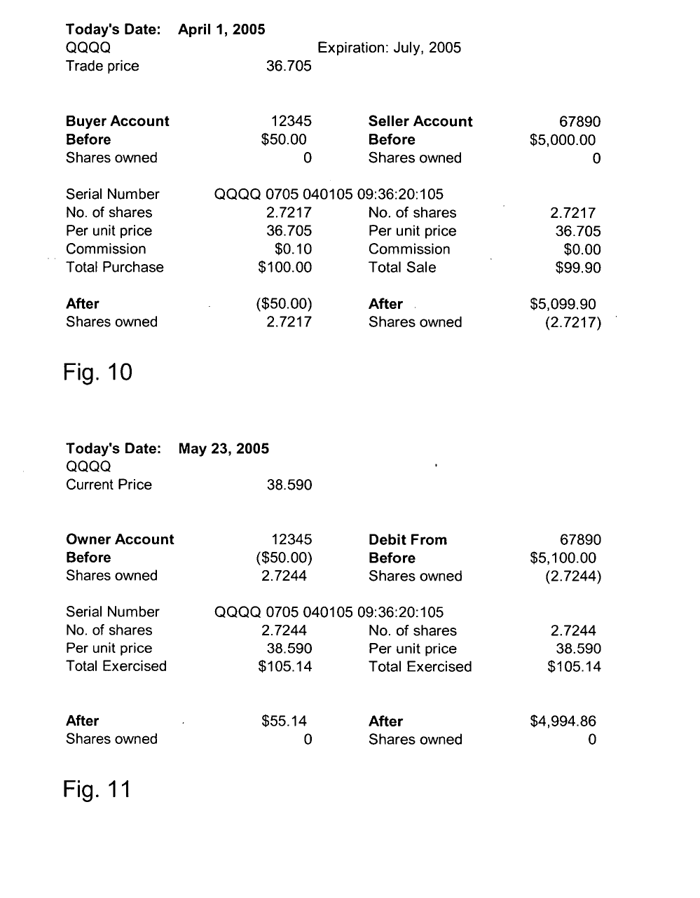

FIG. 10 shows the transaction for FIG. 9 if there is a commission fee of ten cents per round-trip trade. In this illustration, account no. 12345 purchases $100 of the security. A commission fee of ten cents is subtracted from account no. 12345. In this illustration, no commission is charged to the seller. A commission may be assessed on either or both of the buyer and seller by the trading system 1. If desired, an additional commission fee for an odd lot trade, i.e., not a multiple of 100 units, of one cent per round-trip trade may be added. Certain transactions may call for assessment of a penalty fee. The penalty fee may be applied in the same manner as a commission, or may be a transfer between buyer and seller. Commissions and penalties may be collectively referred to as transaction charges.

FIG. 11 shows the transaction in the exercise of the security of FIG. 9 where the user 10 shows a profit from the trade. For example, on May 23, 2005, account no. 12345, the owner of the 2.7244 shares of the security of FIG. 9 decided to exercise his right to sell the shares. The security will be traded by the trading system 1 at the current price posted by the exchange at the instant that the trading system 1 receives the exercise order. If the order is received when the market is closed, the order may be executed at the opening price when the market reopens on the next trade day. As illustrated in FIG. 11, the trade price is 38.59. The trading system 1 retrieves the serial number QQQQ 0705 040105 09:36:20:105 associated with this security, and determines that account no. 67890 is the seller of this security. The trading system 1 then transfers $105.14 from account no. 67890 to account no. 12345. Thus, account 12345 profited by $5.14 by exercising the right. The trading system 1 may transfer a penalty fee from account no. 12345 to account no. 67890 for exercising the right. In the illustration, it is assumed for simplicity in calculation that the cash accounts are not collecting interest.

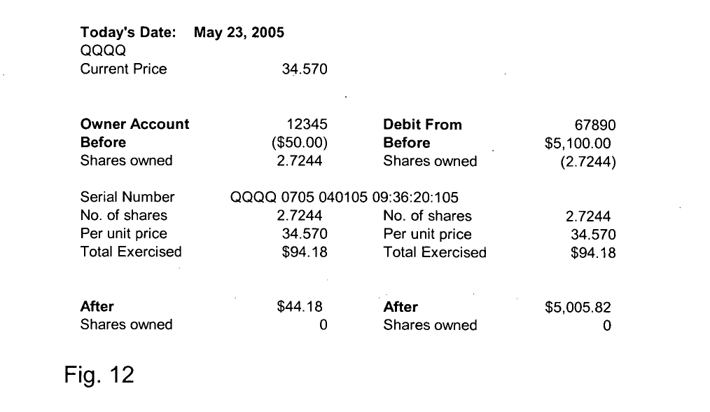

FIG. 12 shows the transaction in the exercise of the security of FIG. 9 where the owner shows a loss from the trade. For example, on May 23, 2005, the index is currently at 34.57. Account no. 12345 exercises because he wants to stop his loss. An order to exercise is entered and is executed at 34.57, the current price posted by the exchange. In this case, the trading system 1 transfers $94.18 from account no. 67890 to account no. 12345. As indicated in FIG. 12, the shares were purchased at 34.57 each. Account 12345's loss from the trade is $5.82. In a preferred form, the owner pays a penalty to the seller for the exercise. Moreover, a short seller also has a right to exercise, after payment of a penalty to the owner. This is advantageous in that a short seller need not be “squeezed.”

System 1 also comprises programs for handling stock splits, cash and stock dividends, and other special situations. These programs may comprise prior art programs. For cash dividends, the cash dividend will be debited from the seller and credited to the owner of the stock on the payable date of the dividend.

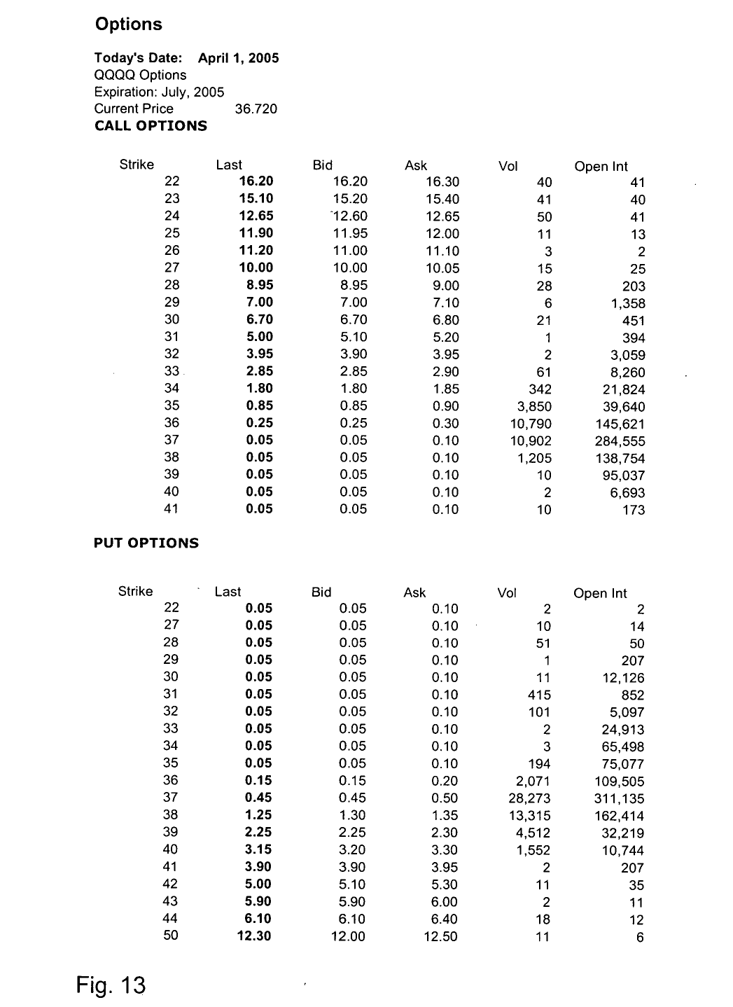

FIG. 13 shows all the existing options for QQQQ with an expiration date of July 2005. At each strike price, the best bid, the best ask, day's total trade volume and the day's total open interest, as posted by the exchange, are also shown.

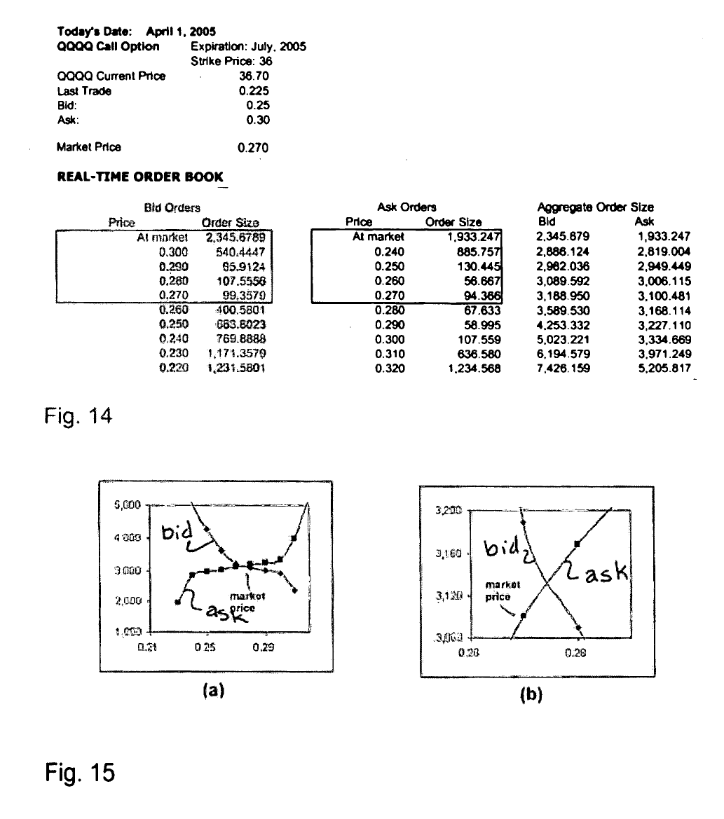

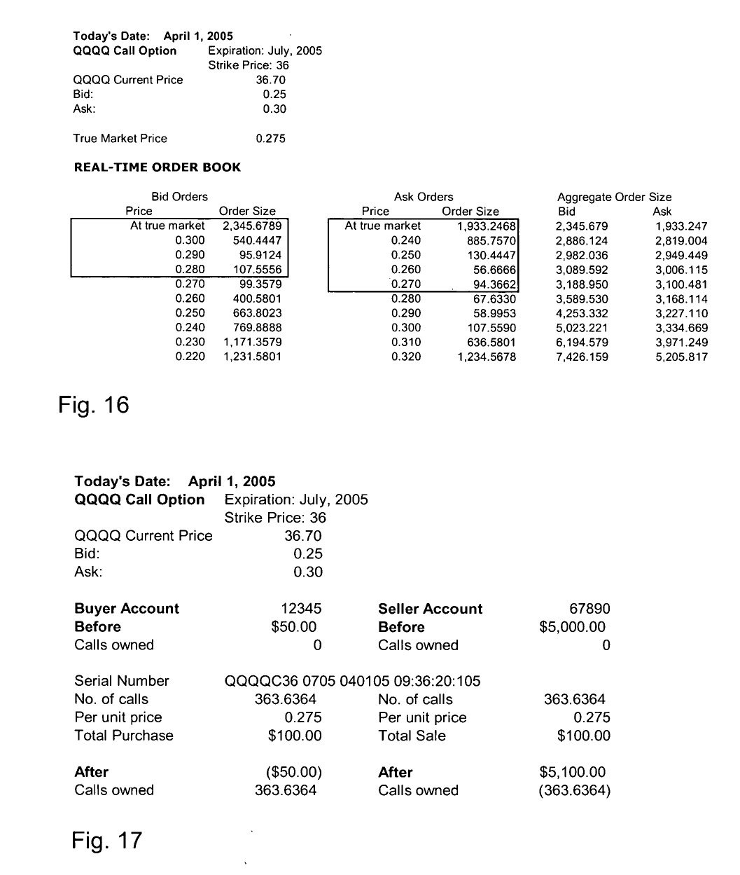

FIG. 14 shows the list of bids and offers displayed on the trading system 1, and the corresponding volumes for an option at a given strike price and expiration date. The list is similar to that for the underlying index seen in FIG. 4. FIG. 15, consists of FIGS. 15a and 15b, which are graphs illustrating aggregate supply and demand curves incorporating the data of FIG. 14. In each graph, the abscissa is price and the ordinate is volume. The aggregate supply and demand curves may be used to determine the “market” or “equilibrium” price, the price at which the market clears. FIG. 15b is a partial, detailed view of FIG. 15a. In each curve marked bid, the volume is the aggregate number of bid orders at the price on the abscissa or at a higher price. In each curve label ask, the volume is the aggregate number of units listed at the price on the abscissa or at a lower price. In this description the number of orders is the number of units for which there is an order. In the preferred form, FIG. 16, the current actual market price is 0.275, the average of the system's posted bid and ask. There are 107.5556 bid orders from various customers at current actual market price or better, but no worse than 0.28, and 94.3662 ask orders from various customers at current actual market price or better, but no worse than 0.27. The system trade matching program 68 crosses the trades where bids and asks are better than or equal to the current actual market price. The filled orders are chosen according to the “First In, First Out” rule. The typical book of bids and offers after crossing is similar to that of FIG. 6.

FIG. 17 shows a transaction recorded by the trading system 1 for a particular trade of a call option. The serial number for the trade is QQQQC36 0705 040105 09:36:20:105. The serial number indicates that the call option, with strike price of 36 and expiration date of the third Friday in July of 2005, was bought on Apr. 1, 2005 at 9:36:20:105 ET. Account Nos. 12345 and 67890 are first time traders of these options. Account No. 12345 is debited $100, and account No. 67890 is credited the same amount for the trade of 363.6364 call options. The trading system 1 records account no. 12345 as the owner of 363.6364 call options and account No. 67890 as the seller of the call options. If account no. 67890 is selling an owned call option and/or if account no. 12345 is covering a short sale of a call option, then the trading system 1 records the transaction in a manner similar to that for a trade of stock or an index.

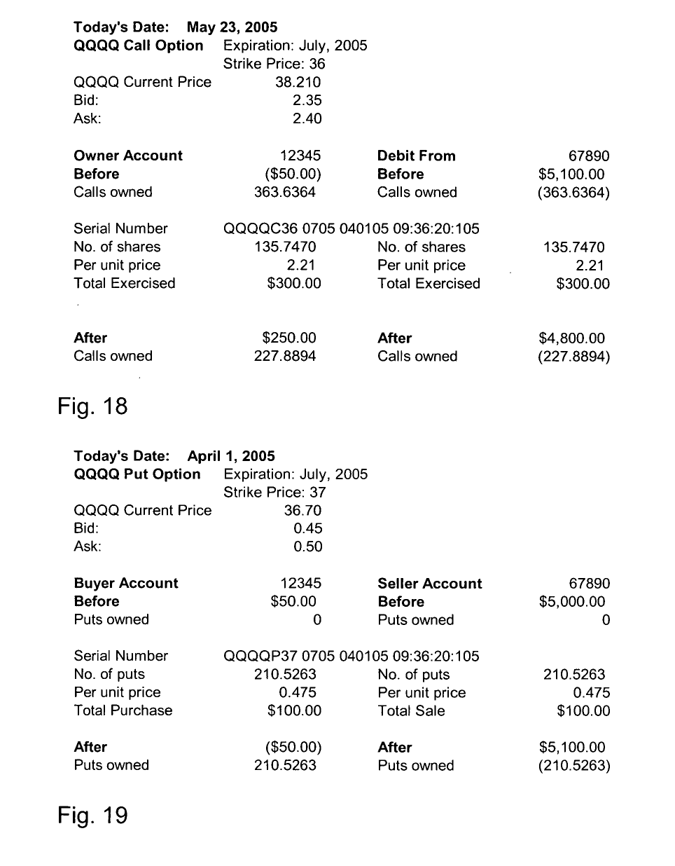

FIG. 18 shows the transaction in the exercise of a portion of the call options of FIG. 17. On May 23, 2005, account no. 12345 decides to exercise $300 of his in the money call options. The options are exercised at the difference of the current price posted in the price database 56 when the trading system 1 receives the exercise order and the strike price, i.e., the price specified in the option. If the order is received when the market is closed, the exercise order will be executed when the market reopens. As illustrated in FIG. 18, the trade price is 2.21. The trading system 1 retrieves the serial number QQQQC36 0705 040105 09:36:20:105 associated with these call options, and determines that account no. 67890 is the seller of these options. The trading system 1 then transfers $300 from account no. 67890 to account no. 12345. Note that account 12345 is still long 227.8894 call options. In a preferred form, a short seller may also have a right to exercise out of the money call options, after payment of a penalty to the owner. This is advantageous in that a short seller need not be “squeezed.”

In a preferred form for the exercise of an in the money call option, the call option is cancelled, and a stock trade is executed in which the owner's account is debited, and the seller's account is credited with the trade value equal to the strike price on record.

FIG. 19 shows a transaction recorded by the trading system 1 for a particular trade of a put option. The serial number for the trade is QQQQP37 0705 040105 09:36:20:105. The serial number indicates that the put option, with strike price of 37 and expiration date of the third Friday in July of 2005, was bought on Apr. 1, 2005 at 9:36:20:105 Eastern time. Account Nos. 12345 and 67890 are first time traders of these options. Account No. 12345 is debited $100, and account No. 67890 is credited the same amount for the trade of 210.5263 put options. The trading system 1 records account no. 12345 as the owner of 210.5263 put options and account no. 67890 as the seller of the put options. If account no. 67890 is selling an owned put option and/or if account no. 12345 is covering a short sale of a put option, then the trading system 1 records the transaction in a manner similar to that for a trade of stock or an index.

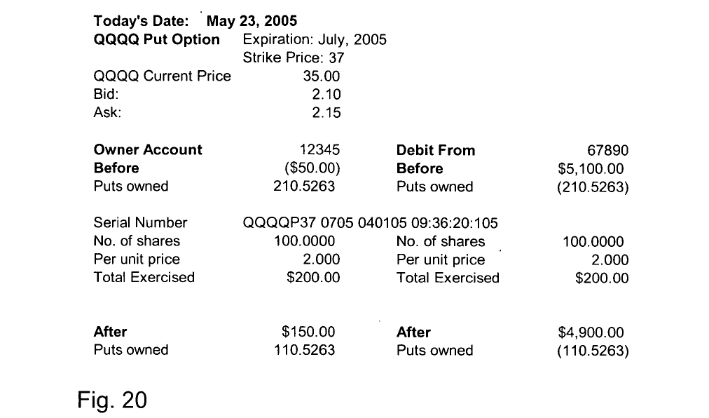

FIG. 20 shows the transaction in the exercise of $200 put options of FIG. 19. Suppose that on May 23, 2005, account no. 12345 decides to exercise $200 of his in the money put options. The options are exercised at the difference of the strike price and the current price listed in the price database 56 when the trading system 1 receives the exercise order. If the order is received when the market is closed, the exercise order will be executed when the market reopens.

As illustrated in FIG. 20, the trade price is 2. The trading system 1 retrieves the serial number QQQQP37 0705 040105 09:36:20:105 associated with these put options, and determines that account no. 67890 is the seller of these options. The trading system 1 then transfers $200 from account no. 67890 to account no. 12345. Note that account 12345 is still long 110.5263 put options. In a preferred form, a short seller may also have a right to exercise out of the money put options, after payment of a penalty to the owner.

In a preferred form for the exercise of an in the money put option, the put option is cancelled, and a stock trade is executed, where the owner's account is credited, and the seller's account is debited with the trade value equal to the strike price on record.

System 1 also comprises programs for handling stock splits and stock dividends, and other special situations. These programs may comprise prior art programs. As is the case in the option exchanges, balances are not adjusted for cash dividends.

The present system provides for efficient handling of transactions and virtually automatic settlement of trades for obligations based on a wide variety of underlying securities. The underlying securities could be stock, options, indexes, derivatives, commodities, coins, currencies or other securities. Derivative transactions include option exercises and recognition of stock splits and dividends with respect to the underlying security. In a preferred form, a short seller has a right to exercise, afterpayment of a penalty to the owner. This is advantageous in that a short seller need not be “squeezed.”

The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

What is claimed is:

1. A trading system for executing and settling derivative obligation transactions comprising:
a price generator to receive current price data for at least an underlying security from a system external to said trading system;
a price data register to provide system users with access to the current price data;
said price generator comprising a source of a current market price for a settlement generator; and
a receiver to receive bid and ask orders from system users.

2. A trading system according to claim 1, further comprising a settlement generator to match bid and ask orders with respect to the current market price to execute trades.

3. A trading system according to claim 2, further comprising a transaction record generator responsive to an execution of a trade by generating a transaction record, the transaction record including a transaction number, the transaction number being coded to be indicative of price information, a bidder's identification and an offeror's identification.

4. A trading system according to claim 3, further comprising an accounts database storing transaction numbers.

5. A trading system according to claim 4, wherein said accounts database stores transaction and account balance information for each user and further comprising an a trade calculator to debit or credit a user's account in accordance with results of a trade.

6. A trading system according to claim 5, wherein said trade calculator accesses a previous transaction number of obligations being traded by a user in a current transaction and compares a current transaction number to the previous transaction number to derive data indicative of trade results for the user.

7. A trading system according to claim 6, in which said settlement generator matches bid and ask orders in accordance with a rule.

8. A trading system according to claim 7, wherein the rule is selected from the group consisting of First-In-First-Out, Last-In-First-Out and trade volume and trade frequency associated with a user placing an order to be matched.

9. A trading system according to claim 6, further comprising a market maker program.

10. A trading system according to claim 6, further comprising a specialist program.

11. A trading system according to claim 5, wherein said trade calculator is configured to assess at least one selected transaction fee.

12. A trading system according to claim 2, further comprising an order register to register a total volume of current bid or ask orders and ask offers at each bid or ask price and to generate current actual market price at a level as a function of a level at which an aggregate number of bid orders at the level or at a higher price equals the aggregate ask orders at the level or at a lower price.

13. A trading system comprising: a price generator to receive current bid and ask price data for a security;
a price data register to provide system users with access to the current price data; and
a receiver to receive buy and sell orders from system users;
a settlement generator to match bid and ask orders to execute trades,
an order register to register a total volume of current bid or ask orders and ask offers at each bid or ask price and to generate current actual market price at a level as a function of a level at which an aggregate number of bid orders at the level or at a higher price equals the aggregate ask orders at the level or at a lower price.

14. A trading system according to claim 13, wherein said price generator is configured to receive current price data for at least an underlying security from a system external to said trading system.

15. A trading system according to claim 14, further comprising a transaction record generator responsive execution of a trade to generate a transaction record, the transaction record including a transaction number, the transaction number being coded to be indicative of price information, a bidder's identification and an offeror's identification.

16. A method for trading a derivative security in a trading system comprising:
receiving current price data for at least an underlying security from a system external to said trading system comprising an inside quote;
providing system users with access to the current price data; and
receiving bid and ask orders from system users.

17. A method according to claim 16, further comprising matching bid and ask orders to execute trades and generating a transaction record responsive to an execution of a trade by generating a transaction record, the transaction record including a transaction number, the transaction number being coded to be indicative of price information, a bidder's identification and an offeror's identification.

18. A method according to claim 17, further comprising accessing a previous transaction number of obligations being traded by a user in a current transaction and compares a current transaction number to the previous transaction number to derive data indicative of trade results for the user.

19. A method according to claim 18, further comprising providing transaction and account balance information for each user and debiting or crediting a user's account in accordance with results of a trade.

20. A method according to claim 19, further comprising selecting a current market price as a function of the inside quote.

21. A method according to claim 19, further comprising selecting a current market price as an average of bid and asked levels of the inside quote.

22. A method according to claim 19, further comprising selecting a current market price as a function of a level at which an aggregate number of bid orders at the level or at a higher price equals the aggregate ask orders at the level or at a lower price.

23. A method for trading a security in a trading system comprising:
receiving bid and ask orders from system users;
providing system users with access to current price data; and
selecting a current market price as a function of a level at which an aggregate number of bid orders at the level or at a higher price equals the aggregate ask orders at the level or at a lower price.

24. A method according to claim 23, wherein selecting a current market price further comprises registering a total volume of bid orders and a total volume of ask orders at each price level at which bids and asks are made.

25. A machine-readable medium that provides instructions, which when executed by processor, cause said processor to perform operations comprising:
receiving current price data for at least an underlying security from a system external to said trading system comprising an inside quote;
providing system users with access to the current price data; and
receiving bid and ask orders from system users.

26. A machine-readable medium according to claim 25 further providing instructions to match bid and ask orders to execute trades, to generate a transaction record responsive to an execution of a trade by generating a transaction record, the transaction record including a transaction number, the transaction number being coded to be indicative of price information, a bidder's identification and an offeror's identification.

27. A machine-readable medium according to claim 26 further providing instructions to access a previous transaction number of obligations being traded by a user in a current transaction and to compare a current transaction number to the previous transaction number to derive data indicative of trade results for the user.

28. A machine-readable medium according to claim 26 further providing instructions to provide transaction and account balance information for each user and debiting or crediting a user's account in accordance with results of a trade.

29. A machine-readable medium according to claim 28 further providing instructions to select a current market price as a function of the inside quote.

30. A machine-readable medium according to claim 28 further providing instructions to select a current market price as an average of bid and asked levels of the inside quote.

31. A machine-readable medium according to claim 28 further providing instructions to select a current market price as a function of a level at which an aggregate number of bid orders at the level or at a higher price equals the aggregate ask orders at the level or at a lower price.

32. A machine-readable medium that provides instructions, which when executed by processor, cause said processor to perform operations comprising:
receiving bid and ask orders from system users;
providing system users with access to current price data; and selecting a current market price as a function of a level at which an aggregate number of bid orders at the level or at a higher price equals the aggregate ask orders at the level or at a lower price.

33. A machine-readable medium according to claim 28 further comprising instructions to register a total volume of bid orders and a total volume of ask orders at each price level at which bids and asks are made.

34. A trading system according to claim 3, comprising an interface for a user to access a prior transaction and to permit the user to sell or buy at a specified pricing formula to an other side of the transaction what the user has bought or sold.

35. A method according to claim 17, further comprising accessing a prior transaction record and permitting a bidder or offeror associated with that transaction to sell or buy at a specified pricing formula to an other side of the transaction what the user has bought or sold.

36. A machine-readable medium according to claim 26, further providing instructions to access a previous transaction record and to permit a bidder or offeror associated with that transaction to sell or buy at a specified pricing formula to an other side of the transaction what the user has bought or sold.
